(19) United States
(12) Patent Application Publication
(10) Pub. No.: US 2024/0211839 A1
(43) Pub. Date: Jun. 27, 2024

(54) BUSINESS DATA PROCESSING SYSTEM AND METHOD FOR AUTOMATICALLY CAPTURING DATA

(71) Applicants: Digiwin Software Co., Ltd, Shanghai (CN); DATA SYSTEMS CONSULTING CO., LTD., New Taipei City (TW)

(72) Inventors: Lei Feng, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/302,820

(22) Filed: Apr. 19, 2023

(30) Foreign Application Priority Data
Dec. 27, 2022 (CN) 202211682755.5

(51) Int. Cl. G06Q 10/0635

(52) U.S. Cl. CPC G06Q 10/0635

(57) ABSTRACT

A business data processing system including a storage device and a processor and a method for automatically capturing data are provided. The storage device is used to store a timing module and a data detection module. The processor is coupled to the storage device and is used to execute the timing module and the data detection module. The timing module outputs a detection command to the data detection module at a preset time, so that the data detection module executes a detection operation. The data detection module calculates a time window according to a previous detection operation, captures detection data from a database in the time window, judges whether the detection data has deduplicated data according to the detection data and recorded data, initiates the deduplicated data to an external business process system, obtains corresponding data initiation information from the external business process system, and updates the recorded data.

### CROSS-REFERENCE TO RELATED APPLICATION

This application claims the priority benefit of China application serial no. 202211682755.5, filed on Dec. 27, 2022. The entirety of the above-mentioned patent application is hereby incorporated by reference herein and made a part of this specification.

### BACKGROUND

### Technical Field

The disclosure relates to a data processing technology, and in particular to a business data processing system and a method for automatically capturing data.

### Description of Related Art

Generally speaking, when the business system adds or revises business data, the business system generates changed business data and store the changed business data into a storage medium. A field for describing the storage time may be recorded in the changed business data. In this regard, the conventional practice is to judge whether there is any changed business data through manual detection, thereby initiating the changed business data to the corresponding business program to generate or update the corresponding business data, so data loss is prone to occur. Moreover, there may be a delay (time difference) between the storage time described in the field recorded in the changed business data and the time when the changed business data is actually stored into the storage medium. Therefore, during the process of detecting the changed business data, data loss may also occur. Even after the changed business data is initiated to the corresponding business program, initiation failure may occur and needs to be corrected by manual inspection.

### SUMMARY

The disclosure provides a business data processing system and a method for automatically capturing data, which can accurately and automatically capture changed business data.

According to an embodiment of the disclosure, a business data processing system of the disclosure includes a storage device and a processor. The storage device is used to store a timing module and a data detection module. The processor is coupled to the storage device and is used to execute the timing module and the data detection module. The timing module outputs a detection command to the data detection module at a preset time, so that the data detection module executes a detection operation. The data detection module calculates a time window of the detection operation according to a previous detection operation, and captures detection data from a database in the time window of the detection operation. The data detection module judges whether the detection data has deduplicated data according to the detection data and recorded data, and initiates the deduplicated data to an external business process system. The data detection module obtains corresponding data initiation information from the external business process system, and updates the recorded data according to the data initiation information.

According to an embodiment of the disclosure, a method for automatically capturing data of the disclosure includes the following steps. A timing module is executed through a processor to output a detection command to a data detection module at a preset time, so that the data detection module executes a detection operation. The data detection module is executed through the processor to calculate a time window of the detection operation according to a previous detection operation. Detection data is captured from a database in the time window of the detection operation through the data detection module. Whether the detection data has deduplicated data is judged according to the detection data and recorded data, and the deduplicated data is initiated to an external business process system through the data detection module. Corresponding data initiation information is obtained from the external business process system, and the recorded data is updated according to the data initiation information through the data detection module.

Based on the above, the business data processing system and the method for automatically capturing data of the disclosure can accurately capture the changed business data, so as to effectively and automatically initiate the changed business data to the business process system.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a business data processing system according to an embodiment of the disclosure.

FIG. 2 is a schematic diagram of multiple modules executed by the business data processing system according to an embodiment of the disclosure.

FIG. 3 is a flowchart of a method for automatically capturing data according to an embodiment of the disclosure.

FIG. 4 is a schematic diagram of a data detection module according to an embodiment of the disclosure.

FIG. 5A and FIG. 5B are flowcharts of a method for automatically capturing data according to another embodiment of the disclosure.

FIG. 6 is a schematic diagram of capturing data according to an exemplary embodiment of the disclosure.

FIG. 7 is a schematic diagram of capturing data according to an exemplary embodiment of the disclosure.

FIG. 8 is a schematic diagram of capturing data according to an exemplary embodiment of the disclosure.

### DETAILED DESCRIPTION OF DISCLOSED EMBODIMENTS

Reference will now be made in detail to the exemplary embodiments of the disclosure, examples of which are illustrated in the drawings. Wherever possible, the same reference numerals are used in the drawings and the description to refer to the same or similar parts.

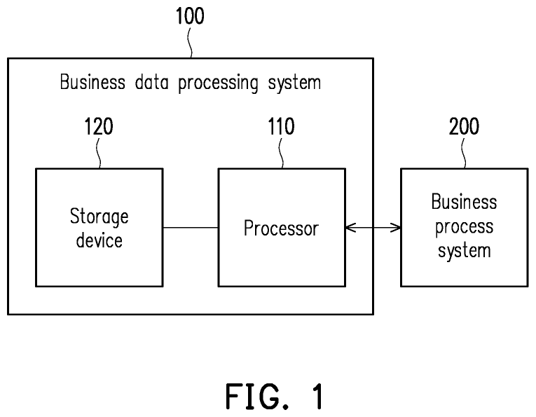

FIG. 1 is a schematic diagram of a business data processing system according to an embodiment of the disclosure. Referring to FIG. 1, a business data processing system 100 includes a processor 110 and a storage device 120. The processor 110 is coupled to the storage device 120 and a business process system 200. The business data processing system 100 may also include a communication interface or a data transmission interface with an actual circuit element, so that the processor 110 may communicate or perform data transmission with the external business process system 200. In the embodiment, the business data processing system 100 and the business process system 200 may be, for example, respectively implemented on a cloud server or a private server inside an enterprise. The business process system 200 may also be integrated in an enterprise resource planning (ERP) system and may execute multiple application programming interfaces (API) to call multiple business program modules. In an embodiment, the business program module refers to a program for executing a specific business function according to business data, for example, a program that may be used to execute a purchase order generation function according to purchase data or for example, a program that may be used to execute a requisition order generation function according to requisition data, which is not limited by the disclosure.

In the embodiment, the processor 110 of the business data processing system 100 may include, for example, a central processing unit (CPU), other programmable general-purpose or specific-purpose microprocessors, digital signal processors (DSP), application specific integrated circuits (ASIC), programmable logic devices (PLD), other similar processing circuits, or a combination of the devices.

The storage device 120 may also implement a remote cloud storage service or a local data storage service. The storage device 120 may include a memory and/or a database, wherein the memory may be, for example, a non-volatile memory (NVM). The storage device 120 may store relevant programs, modules, systems, or algorithms for implementing various embodiments of the disclosure, so as to be accessed and executed by the processor 110 to implement relevant functions and operations described in the various embodiments of the disclosure. The storage device 120 may cache changed business data and setting information of a time window (also referred to as a time interval) described in the various embodiments of the disclosure. In addition, the changed business data described in the various embodiments of the disclosure may be business data generated by a business system due to modifications or updates, and the changed business data may record relevant business fields, such as time information of storage and specific business information. The changed business data described in the various embodiments of the disclosure may refer to a business record generated or modified by the business system during the process of processing business. The business record may contain information of business creation and/or modification time. The business record may describe information about business conditions, the modification time, and key fields that may uniquely determine and describe business information. In addition, the information of the modification time may refer to the time when the business is modified, such as the modification time recorded when the amount of a receipt is revised and operated through a front-end page. It should be noted that the modification time here is different from the time when revision information actually falls into the database.

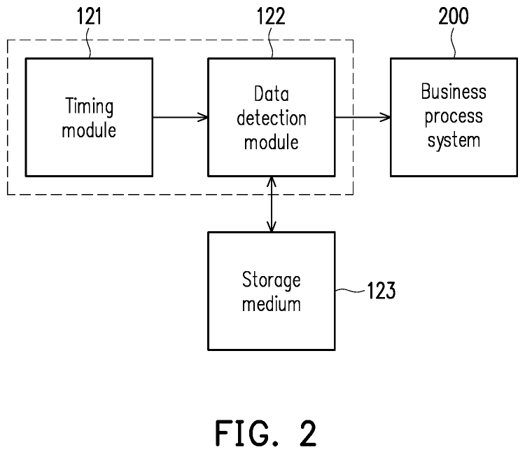

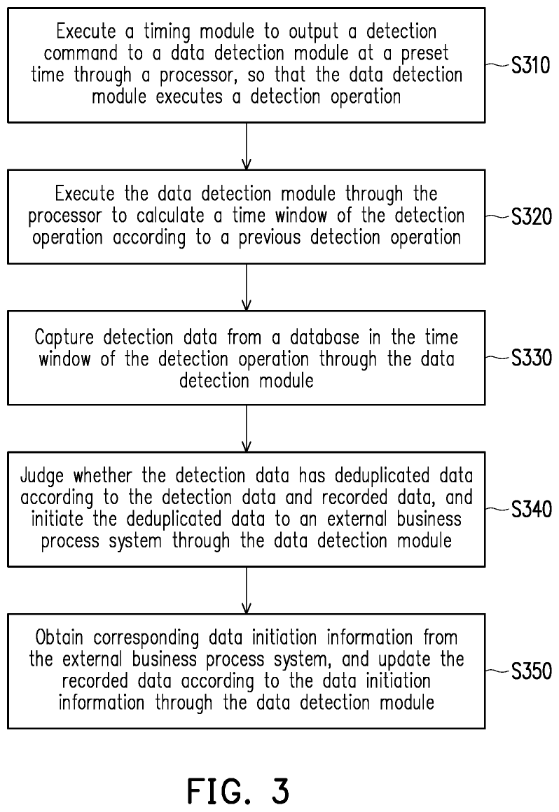

FIG. 2 is a schematic diagram of multiple modules executed by the business data processing system according to an embodiment of the disclosure. FIG. 3 is a flowchart of a method for automatically capturing data according to an embodiment of the disclosure. First referring to FIG. 1 and FIG. 2, the storage device 120 may store a timing module 121 and a data detection module 122. The timing module 121 and the data detection module 122 may be implemented, for example, by programming languages such as JavaScript object notation (JSON), extensible markup language (XML), and YAML, but the disclosure is not limited thereto. The data detection module 122 may be used, for example, to detect the changed business data stored into a storage medium 123. The data detection module 122 may also detect time window information cached in the storage device 120 and recorded data generated by the data detection module 122. In the embodiment, the storage medium 123 may refer to the storage device 120 configured in the business data processing system 100 or a storage device in a cloud server or a local server. Moreover, the data detection module 122 may access the storage medium 123 through, for example, a hypertext transfer protocol (HTTP).

Then, referring to FIG. 1 to FIG. 2, the business data processing system 100 executes, for example, Steps S310 to S350 below. In Step S310, the processor 110 may execute the timing module 121 to output a detection command to the data detection module 122 at a preset time, so that the data detection module 122 executes a detection operation. In Step S320, the processor 110 may execute the data detection module 122 to calculate a time window of the detection operation according to a previous detection operation. In the embodiment, at least part of the time window of the detection operation is overlapped with a time window of the previous detection operation. In Step S330, the data detection module 122 may capture detection data from the storage medium 123 in the time window of the detection operation. In the embodiment, the data detection module 122 may capture changed business data stored into the storage medium 123 in a specific time window to be used as the detection data. In Step S340, the data detection module 122 may judge whether the detection data has deduplicated data according to the detection data and recorded data, and initiate the deduplicated data to the external business process system 200. In Step S350, the data detection module 122 may obtain corresponding data initiation information from the external business process system 200, and update the recorded data according to the data initiation information. Therefore, the business data processing system 100 of the embodiment may automatically judge the changed business data generated by a business system due to a business change, and automatically initiate the changed business data to the business process system 200 to achieve a corresponding business purpose. For example, changed purchase data (for example, a change in the purchase amount of a certain item) generated due to a change in a purchase plan may be automatically detected by the business data processing system 100, and correction of a purchase order or a relevant business process program to update the purchase order is correspondingly executed.

In an embodiment, the recorded data of the embodiment may also be recorded using a highly available cache service. Moreover, the highly available cache service may be implemented in the form of cloud service and accessed through a hypertext transfer protocol. Alternatively, the recorded data may also be directly stored in the local storage device 120, even in the form of file data, and data interaction may be performed through inter-process communication or an operating file interface in an operating system.

In an embodiment, the time window information and an execution result of the previous detection operation of the embodiment may be, for example, stored in a relational database. Moreover, the relational database may be implemented in the form of cloud service and accessed through the hypertext transfer protocol. Alternatively, the time window information and the execution result of the previous detection operation of the embodiment may also be directly stored in the local storage device 120, and data interaction may be performed through inter-process communication or the operation file interface in the operating system.

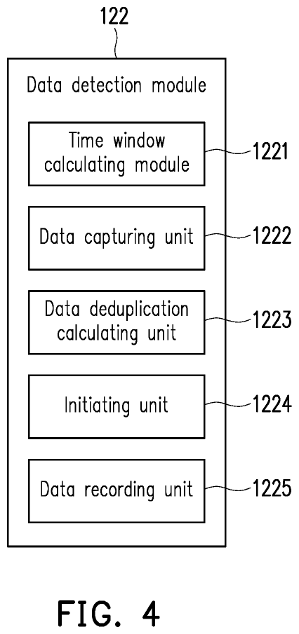

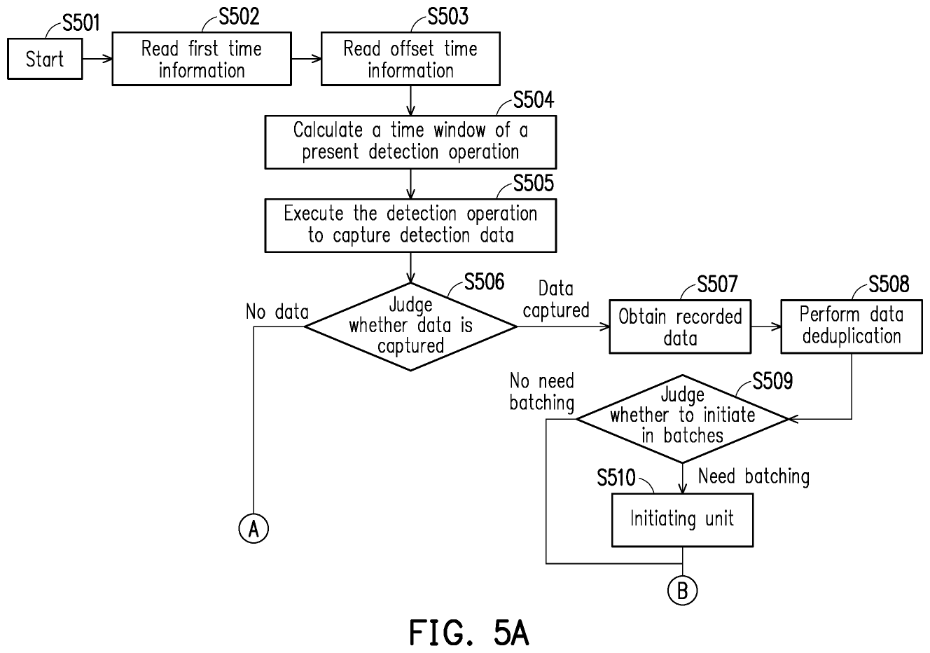

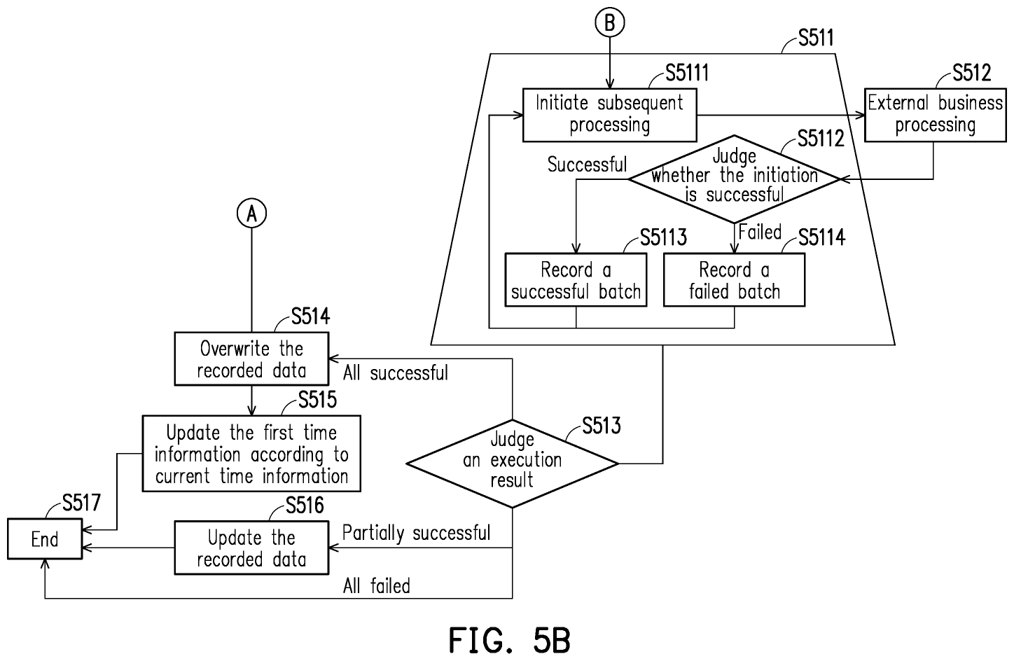

FIG. 4 is a schematic diagram of a data detection module according to an embodiment of the disclosure. FIG. 5A and FIG. 5B are flowcharts of a method for automatically capturing data according to another embodiment of the disclosure. Referring to FIG. 4 first, in the embodiment, the data detection module 122 may further include, for example, a time window calculating module 1221, a data capturing unit 1222, a data deduplication calculating unit 1223, an initiating unit 1224, and a data recording unit 1225. Then, referring to FIG. 1, FIG. 3, FIG. 4, FIG. 5A, and FIG. 5B, the business data processing system 100 may execute Steps S501 to S517 below. In Step S501, the processor 110 of the business data processing system 100 may execute the timing module 121 to output a detection command to the data detection module 122 at a preset time, so that the data detection module 122 executes a detection operation. In Step S502, the processor 110 may execute the time window calculating module 1221 to read temporarily stored first time information. In Step S503, the processor 110 may execute the time window calculating module 1221 to read temporarily stored offset time information. In Step S504, the processor 110 may execute the time window calculating module 1221 to calculate a time window of the present detection operation. In this regard, the time window calculating module 1221 may calculate the time window of the present detection operation according to the first time information and a current time. The time window calculating module 1221 may determine a detection start time of the detection operation according to the first time information, and use the current time as a detection end time of the detection operation. The time window calculating module 1221 may calculate the detection start time according to the first time information and the offset time information. It should be noted that the offset amount of the offset time information described in the various embodiments of the disclosure needs to be configured in advance, and the time length of an offset time may affect the number of duplicated data, so the time length may be reasonably estimated in advance according to the responsiveness of the actually detected (observed) business data system and/or the time deviation of the server.

In Step S505, the processor 110 may execute the data capturing unit 1222 to capture detection data from the storage medium 123. The detection data is changed business data. In Step S506, the processor 110 may judge whether the changed business data is captured. If there is no data, the processor 110 may execute Step S514 below. If there is data, the processor 110 may execute Step S507. In Step S507, the processor 110 may execute the data deduplication calculating unit 1223 to obtain recorded data. In Step S508, the processor 110 may execute the data deduplication calculating unit 1223 to perform data deduplication and generate deduplicated data. In the embodiment, the data deduplication calculating unit 1223 may compare the detection data and the recorded data to remove data in the detection data that is duplicated in the recorded data (indicating that the changed business data is already successfully initiated to the business process system 200 in a previous detection operation).

In Step S509, the processor 110 may execute the initiating unit 1224 to judge whether the data amount of the deduplicated data is greater than a preset data amount threshold, so as to decide whether to initiate the deduplicated data in batches. If the initiation needs to be in batches, in Step S510, the initiating unit 1224 may divide the deduplicated data into batches, and cyclically execute Step S511 according to the batches. If the initiation does not need to be in batches, the initiating unit 1224 may execute Step S511 once (which may be interpreted as one batch). In other words, if the data amount of the deduplicated data is too large, in order to save computing time and/or computing resources, the initiating unit 1224 may initiate the deduplicated data in batches.

Step S511 may include further executing Steps S5111 to S5114. In Step S5111, the processor 110 may execute the initiating unit 1224 to initiate subsequent processing according to the deduplicated data. In Step S512, the processor 110 may send the deduplicated data to the external business process system 200 for external business processing. In Step S5112, the external business process system 200 may return corresponding data initiation information to the data detection module 122. In Step S5112, the data detection module 122 may judge whether a corresponding business operation is successfully initiated according to the data initiation information. If the initiation is successful, in Step S5113, the data detection module 122 may record a successful batch. If the initiation fails, in Step S5114, the data detection module 122 may record a failed batch. In Step S513, the data detection module 122 may judge an execution result.

If all the batches are successfully initiated, in Step S514, the processor 110 may execute the data recording unit 1225 to overwrite the recorded data. The data recording unit 1225 may overwrite the recorded data by the detection data obtained in the present detection operation. In Step S515, the data detection module 122 may update the first time information according to current time information, so as to judge a time window of a next detection operation. If a part of the batches is successfully initiated, in Step S516, the processor 110 may execute the data recording unit 1225 to update the recorded data. The data recording unit 1225 may update a part of the detection data that is successfully initiated (that is, a part of the changed business data) into the recorded data for deduplication judgment of the next detection operation. If all the batches fail the initiation, in Step S517, the data detection module 122 ends the present detection operation and executes the next detection operation.

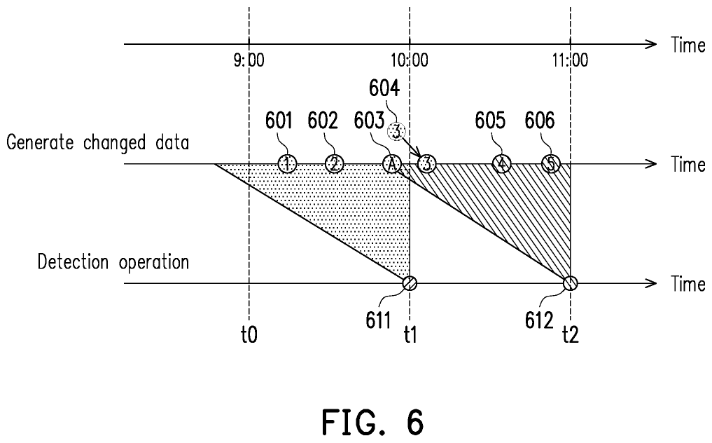

For example, please refer to FIG. 6 and Table 1 below together. FIG. 6 is a schematic diagram of capturing data according to an exemplary embodiment of the disclosure. In addition, Table 1 below is used to illustrate the detection and the deduplication process of the changed business data. Between time t0 and time t1, changed business data 601 (indicated as “1”), changed business data 602 (indicated as “2”), changed business data 603 (indicated as “A”), and changed business data 604 (indicated as “3”) are initiated to be written into the storage medium 123. Between time t1 and time t2, changed business data 605 (indicated as “4”) and changed business data 605 (indicated as “5”) are initiated to be written into the storage medium 123. In the example, although the changed business data 604 (indicated as “3”) is initiated between time t0 and time t1, the time when the changed business data 604 (indicated as “3”) is actually written into the storage medium 123 falls between time t1 and time t2. In the example, time t0 to time t2 may respectively correspond to time “9:00”, “10:00”, and “11:00”.

In this regard, in a detection operation 611, the processor 110 may execute Steps S501 to S504 above to calculate the time window of the detection data of the detection operation 611. The first time information may, for example, record time “09:00” and the offset time information may, for example, record 5 minutes. The time window calculating module 1221 may determine the detection start time of the detection operation according to the first time information (“09:00”), and use the current time (“10:00”) as the detection end time of the detection operation. The time window calculating module 1221 may subtract the offset time information (“0:05”) from the first time information (“09:00”) to calculate the detection start time as “8:55”. Also, the time window calculating module 1221 may use the current time (“10:00”) as the detection end time. Therefore, the time window of the detection data of the detection operation 611 is “8:55” to “10:00”. Next, the processor 110 may execute Step S505 and Step S506 above to capture detection data such as {1, 2, A}, and execute Step S507 above to obtain the recorded data (assuming that this is the first detection, so the recorded data is empty). Next, the processor 110 may execute Step S508 above to perform data deduplication. The processor 110 may compare the detection data ({1, 2, A}) and the recorded data to obtain deduplicated data as {1, 2, A}. Next, the processor 110 may execute Step S509 to Step S512 above to provide the deduplicated data ({1, 2, A}) to the business process system 200 to initiate the corresponding business program, and the processor 110 may execute Step S513 and Step S514 above to receive the data initiation information to update the recorded data. The recorded data may be overwritten by the detection data ({1, 2, A}) for use in a next detection operation 612. Finally, the processor 110 may execute Step S515 above to update the current time information (“10:00”) to new first time information.

In the detection operation 612, the processor 110 may execute Steps S501 to S504 above again to calculate the time window of the detection data of the detection operation 612. The time window calculating module 1221 may determine the detection start time of the detection operation according to the first time information (“10:00”), and use the current time (“11:00”) as the detection end time of the detection operation. The time window calculating module 1221 may subtract the offset time information (“0:05”) from the first time information (“10:00”) to calculate the detection start time as “9:55”. Also, the time window calculating module 1221 may use the current time (“11:00”) as the detection end time. Therefore, the time window of the detection data of the detection operation 612 is “9:55” to “11:00”. Next, the processor 110 may execute Step S505 and Step S506 above to capture detection data such as {A, 3, 4, 5}, and execute Step S507 above to obtain recorded data ({1, 2, A}). Next, the processor 110 may execute Step S508 above to perform data deduplication. The processor 110 may compare the detection data ({A, 3, 4, 5}) and the recorded data ({1, 2, A}) to obtain deduplicated data as {3, 4, 5}. Next, the processor 110 may execute Step S509 to Step S512 above to provide the deduplicated data ({3, 4, 5}) to the business process system 200 to initiate the corresponding business program, and the processor 110 may execute Step S513 and Step S514 above to receive the data initiation information to update the recorded data. The recorded data may be overwritten by the detection data ({A, 3, 4, 5}) for use in the next detection operation. Finally, the processor 110 may execute Step S515 above to update the current time information (“11:00”) to the new first time information.

In other words, in the above example, since the detection operation 611 and the detection operation 612 are partially overlapped, and together with the operation of data deduplication, the processor 110 may correctly provide all the changed business data stored in the storage medium 123 in the detection operation 611 and the detection operation 612 to the external business process system 200 to initiate the corresponding business program, which can effectively prevent the changed business data 604 (indicated as “3”) from being omitted for detection due to the time difference when the data is actually stored in the storage medium 123.

TABLE 1

| | Detection | Detection |
|---|---|---|
| | operation 611 | operation 612 |
| Detection data | {1, 2, A} | {A, 3, 4, 5} |
| Deduplicated data | {1, 2, A} | {3, 4, 5} |
| Successful initiation | {1, 2, A} | {3, 4, 5} |
| Recorded data | {1, 2, A} | {A, 3, 4, 5} |

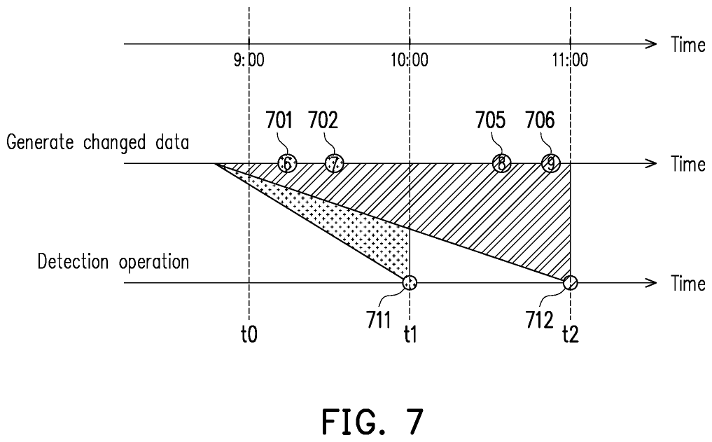

For example, please refer to FIG. 7 together. FIG. 7 is a schematic diagram of capturing data according to an exemplary embodiment of the disclosure. In addition, Table 2 below is used to illustrate the detection and the deduplication process of the changed business data. Between time t0 and time t1, changed business data 701 (indicated as “6”) and changed business data 702 (indicated as “7”) are initiated to be written into the storage medium 123. Between time t1 and time t2, changed business data 703 (indicated as “8”) and changed business data 704 (indicated as “9”) are initiated to be written into the storage medium 123. In the example, it is assumed that the changed business data 702 (indicated as “7”) fails the initiation. In the example, time t0 to time t2 may respectively correspond to time “9:00”, “10:00”, and “11:00”.

In this regard, in a detection operation 711, the processor 110 may execute Steps S501 to S504 above to calculate the time window of the detection data of the detection operation 711. The first time information may, for example, record time “09:00” and the offset time information may, for example, record 5 minutes. The time window calculating module 1221 may determine the detection start time of the detection operation according to the first time information (“09:00”), and use the current time (“10:00”) as the detection end time of the detection operation. The time window calculating module 1221 may subtract the offset time information (“0:05”) from the first time information (“09:00”) to calculate the detection start time as “8:55”. Also, the time window calculating module 1221 may use the current time (“10:00”) as the detection end time. Therefore, the time window of the detection data of the detection operation 711 is “8:55” to “10:00”. Then, the processor 110 may execute Step S505 and Step S506 above to capture detection data such as {6, 7}, and execute Step S507 above to obtain the recorded data (assuming that this is the first detection, so the recorded data is empty). Next, the processor 110 may execute Step S508 above to perform data deduplication. The processor 110 may compare the detection data ({6, 7}) and the recorded data to obtain deduplicated data as {6, 7}. Next, the processor 110 may execute Step S509 to Step S512 above to provide the deduplicated data ({6, 7}) to the business process system 200 to initiate the corresponding business program, and the processor 110 may execute Step S516 above to receive the data initiation information to update the recorded data. The recorded data may be partially updated as {6} for use in a next detection operation 712. In the example, the first time information is not updated.

In the detection operation 712, the processor 110 may execute Steps S501 to S504 above again to calculate the time window of the detection data of the detection operation 712. The time window calculating module 1221 may determine the detection start time of the detection operation according to the first time information (“09:00”), and use the current time (“11:00”) as the detection end time of the detection operation. The time window calculating module 1221 may subtract the offset time information (“0:05”) from the first time information (“09:00”) to calculate the detection start time as “8:55”. Also, the time window calculating module 1221 may use the current time (“11:00”) as the detection end time. Therefore, the time window of the detection data of the detection operation 712 is “8:55” to “11:00”. Next, the processor 110 may execute Step S505 and Step S506 above to capture detection data such as {6, 7, 8, 9}, and execute Step S507 above to obtain the recorded data ({6}). Next, the processor 110 may execute Step S508 above to perform data deduplication. The processor 110 may compare the detection data ({6, 7, 8, 9}) and the recorded data ({6}) to obtain deduplicated data as {7, 8, 9}. Next, the processor 110 may execute Steps S509 to Step S512 above to provide the deduplicated data ({7, 8, 9}) to the business process system 200 to initiate the corresponding business program, and the processor 110 may execute Step S513 and Step S514 above to receive the data initiation information to update the recorded data. The recorded data may be overwritten by the successfully initiated detection data ({6, 7, 8, 9}) for use in the next detection operation. Finally, the processor 110 may execute Step S515 above to update the current time information (“11:00”) to the new first time information.

In other words, in the above example, since the time window of the detection operation 712 may cover the time window of the previous detection operation 712 in which the changed business data is not completely successfully initiated, and together with the operation of data deduplication, the processor 110 may correctly provide all the changed business data stored in the storage medium 123 in the detection operation 711 and the detection operation 712 to the external business process system 200 to initiate the corresponding business program, which can effectively prevent the business program corresponding to the changed business data 702 from being omitted for initiation due to the changed business data 702 (indicated as “7”) being not successfully initiated in the detection operation 711.

TABLE 2

| | Detection | Detection |
|---|---|---|
| | operation 711 | operation 712 |
| Detection data | {6, 7} | {6, 7, 8, 9} |
| Deduplicated data | {6, 7} | {7, 8, 9} |
| Successful initiation | {6} | {7, 8, 9} |
| Recorded data | {6} | {6, 7, 8, 9} |

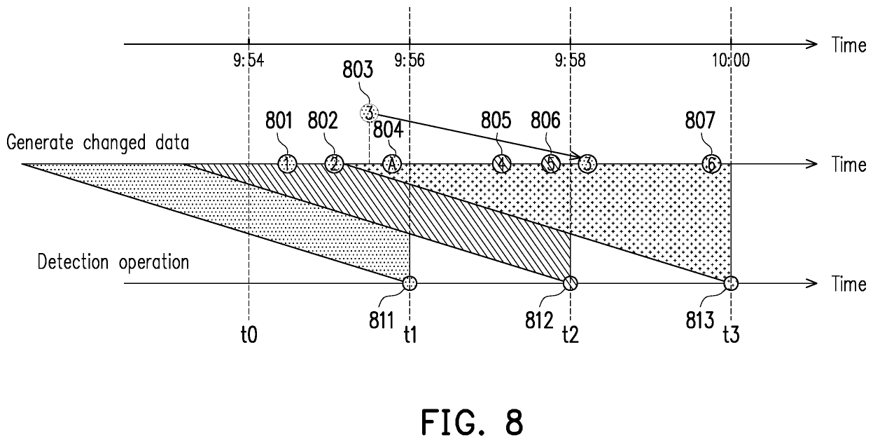

For example, please refer to FIG. 8 together. FIG. 8 is a schematic diagram of capturing data according to an exemplary embodiment of the disclosure. In addition, Table 3 below is used to illustrate the detection and the deduplication process of the changed business data. Between time t0 and time t1, changed business data 801 (indicated as “1”), changed business data 802 (indicated as “2”), changed business data 803 (indicated as “3”), and changed business data 804 (indicated as “A”) are initiated to be written into the storage medium 123. Between time t1 and time t2, changed business data 805 (indicated as “4”) and changed business data 806 (indicated as “5”) are initiated to be written into the storage medium 123. Between time t2 and time t3, changed business data 807 (indicated as “6”) is initiated to be written into the storage medium 123. In the example, it is assumed that the changed business data 702 (indicated as “7”) fails the initiation. In the example, although the changed business data 803 (indicated as “3”) is initiated between time t0 and time t1, the time when the changed business data 803 (indicated as “3”) is actually written into the storage medium 123 falls between time t2 and time t3. In the example, time t0 to time t3 may respectively correspond to time “9:54”, “9:56”, “9:58”, and “10:00”.

In this regard, in a detection operation 811, the processor 110 may execute Steps S501 to S504 above to calculate the time window of the detection data of the detection operation 811. The first time information may, for example, record time “09:54” and the offset time information may, for example, record 3 minutes. The time window calculating module 1221 may determine the detection start time of the detection operation according to the first time information (“09:54”), and use the current time (“09:56” as the detection end time of the detection operation. The time window calculating module 1221 may subtract the offset time information (“0:03”) from the first time information (“09:54”) to calculate the detection start time as “09:51”. Also, the time window calculating module 1221 may use the current time (“09:56”) as the detection end time. Therefore, the time window of the detection data of the detection operation 711 is “09:51” to “09:56”. Next, the processor 110 may execute Step S505 and Step S506 above to capture detection data such as {1, 2, A}, and execute Step S507 above to obtain the recorded data (assuming that this is the first detection, so the recorded data is empty). Next, the processor 110 may execute Step S508 above to perform data deduplication. The processor 110 may compare the detection data ({1, 2, A}) and the recorded data to obtain deduplicated data as {1, 2, A}. Next, the processor 110 may execute Step S509 to Step S512 above to provide the deduplicated data ({1, 2, A}) to the business process system 200 to initiate the corresponding business program, and the processor 110 may execute Step S516 above to receive the data initiation information to update the recorded data. The recorded data may be partially updated as {1, 2, A} for use in a next detection operation 812. Finally, the processor 110 may execute Step S515 above to update the current time information (“09:56”) to the new first time information.

In the detection operation 812, the processor 110 may execute Steps S501 to S504 above again to calculate the time window of the detection data of the detection operation 812. The time window calculating module 1221 may determine the detection start time of the detection operation according to the first time information (“09:56”), and use the current time (“09:56”) as the detection end time of the detection operation. The time window calculating module 1221 may subtract the offset time information (“0:03”) from the first time information (“09:56”) to calculate the detection start time as “09:53”. Also, the time window calculating module 1221 may use the current time (“09:56”) as the detection end time. Therefore, the time window of the detection data of the detection operation 812 is “09:53” to “09:56”. Next, the processor 110 may execute Step S505 and Step S506 above to capture detection data such as {1, 2, A, 4, 5}, and execute Step S507 above to obtain the recorded data ({1, 2, A}). Next, the processor 110 may execute Step S508 above to perform data deduplication. The processor 110 may compare the detection data ({1, 2, A, 4, 5}) and the recorded data ({1, 2, A}) to obtain deduplicated data as {4, 5}. Next, the processor 110 may execute Steps S509 to Step S512 above to provide the deduplicated data ({7, 8, 9}) to the business process system 200 to initiate the corresponding business program, and the processor 110 may execute Step S513 and Step S514 above to receive the data initiation information to update the recorded data. The recorded data may be overwritten by the detection data ({1, 2, A, 4, 5}) for use in the next detection operation. Finally, the processor 110 may execute Step S515 above to update the current time information (“09:58”) to the new first time information.

In a detection operation 813, the processor 110 may execute Steps S501 to S504 above again to calculate the time window of the detection data of the detection operation 813. The time window calculating module 1221 may determine the detection start time of the detection operation according to the first time information (“09:58”), and use the current time (“10:00”) as the detection end time of the detection operation. The time window calculating module 1221 may subtract the offset time information (“0:03”) from the first time information (“09:58”) to calculate the detection start time as “09:55”. Also, the time window calculating module 1221 may use the current time (“10:00”) as the detection end time. Therefore, the time window of the detection data of the detection operation 813 is “09:55” to “10:00”. Next, the processor 110 may execute Step S505 and Step S506 above to capture detection data such as {A, 4, 5, 3, 6}, and execute Step S507 above to obtain the recorded data ({1, 2, A, 4, 5}). Next, the processor 110 may execute Step S508 above to perform data deduplication. The processor 110 may compare the detection data ({A, 4, 5, 3, 6}) and the recorded data ({1, 2, A, 4, 5}) to obtain deduplicated data as {3, 6}. Next, the processor 110 may execute Step S509 to Step S512 above to provide the deduplicated data ({3, 6}) to the business process system 200 to initiate the corresponding business program, and the processor 110 may execute Step S513 and Step S514 above to receive the data initiation information to update the recorded data. The recorded data may be overwritten by the detection data ({A, 4, 5, 3, 6}) for use in the next detection operation. Finally, the processor 110 may execute Step S515 above to update the current time information (“10:00”) to the new first time information.

In other words, in the above example, since the time lengths of the time windows of the detection operations 811 to 813 are relatively short, the time windows of the detection operations may be overlapped, and together with the operation of data deduplication, the changed business data 803 (indicated as “3”) can be effectively prevented from being omitted for detection due to the relatively serious storage time delay of the changed business data 803 (indicated as “3”).

TABLE 3

| | Detection | Detection | Detection |
|---|---|---|---|
| | operation 811 | operation 812 | operation 813 |
| Detection | {1, 2, A} | {1, 2, A, 4, 5} | {A, 4, 5, 3, 6} |
| data | | | |
| Deduplicated | {1, 2, A} | {4, 5} | {3, 6} |
| data | | | |
| Successful | {1, 2, A} | {4, 5} | {3, 6} |
| initiation | | | |
| Recorded | {1, 2, A} | {1, 2, A, 4, 5} | {A, 4, 5, 3, 6} |
| data | | | |

In summary, the business data processing system and the method for automatically capturing data of the disclosure can accurately capture the changed business data through overlapping at least part of the time windows of the detection operations, so as to effectively prevent data omission due to data storage time delay or data initiation failure, and the changed business data generated by the business system can be automatically sent to the business process system until the data initiation is successful.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A business data processing system, comprising:
a storage device, used to store a timing module and a data detection module; and
a processor, coupled to the storage device and used to execute the timing module and the data detection module,
wherein the timing module outputs a detection command to the data detection module at a preset time, so that the data detection module executes a detection operation,
wherein the data detection module calculates a time window of the detection operation according to a previous detection operation, and captures detection data from a database in the time window of the detection operation,
wherein the data detection module judges whether the detection data has deduplicated data according to the detection data and recorded data, and initiates the deduplicated data to an external business process system,
wherein the data detection module obtains corresponding data initiation information from the external business process system, and updates the recorded data according to the data initiation information.

2. The business data processing system according to claim 1, wherein the data detection module reads first time information, and calculates the time window of the detection operation according to the first time information and a current time.

3. The business data processing system according to claim 2, wherein the data detection module determines a detection start time of the detection operation according to the first time information, and uses the current time as a detection end time of the detection operation.

4. The business data processing system according to claim 3, wherein the data detection module calculates the detection start time according to the first time information and offset time information.

5. The business data processing system according to claim 2, wherein when the data detection module judges that all the deduplicated data is successfully initiated according to the data initiation information, the data detection module updates the first time information according to information of the current time.

6. The business data processing system according to claim 5, wherein when the data detection module judges that not all the deduplicated data is successfully initiated according to the data initiation information, the data detection module does not update the first time information.

7. The business data processing system according to claim 1, wherein the data detection module records successfully initiated data in the deduplicated data according to the data initiation information to update the recorded data.

8. The business data processing system according to claim 1, wherein the detection data is changed business data.

9. The business data processing system according to claim 1, wherein the data detection module judges whether a data amount of the deduplicated data is greater than a preset data amount threshold to decide whether to initiate the deduplicated data in batches.

10. The business data processing system according to claim 1, wherein at least part of the time window of the detection operation is overlapped with a time window of the previous detection operation.

11. A method for automatically capturing data, comprising:
executing, through a processor, a timing module to output a detection command to a data detection module at a preset time, so that the data detection module executes a detection operation;
executing, through the processor, the data detection module to calculate a time window of the detection operation according to a previous detection operation;
capturing, through the data detection module, detection data from a database in the time window of the detection operation;
judging, through the data detection module, whether the detection data has deduplicated data according to the detection data and recorded data, and initiating the deduplicated data to an external business process system; and
obtaining, through the data detection module, corresponding data initiation information from the external business process system, and updating the recorded data according to the data initiation information.

12. The method according to claim 11, wherein the step of calculating the time window of the detection operation comprises:
reading, through the data detection module, first time information, and calculating the time window of the detection operation according to the first time information and a current time.

13. The method according to claim 12, wherein the step of calculating the time window of the detection operation according to the first time information and the current time comprises:
determining, through the data detection module, a detection start time of the detection operation according to the first time information, and using the current time as a detection end time of the detection operation.

14. The method according to claim 13, wherein the step of determining the detection start time of the detection operation according to the first time information comprises:
calculating, through the data detection module, the detection start time according to the first time information and offset time information.

15. The method according to claim 12, further comprising:
updating, through the data detection module, the first time information according to information of the current time when the data detection module judges that all the deduplicated data is successfully initiated according to the data initiation information.

16. The method according to claim 15, further comprising:
not updating, through the data detection module, the first time information when the data detection module judges that not all the deduplicated data is successfully initiated according to the data initiation information.

17. The method according to claim 11, wherein the step of updating the recorded data comprises:
recording, through the data detection module, successfully initiated data in the deduplicated data according to the data initiation information to update the recorded data.

18. The method according to claim 11, wherein the detection data is changed business data.

19. The method according to claim 11, wherein the step of initiating the deduplicated data comprises:
judging, through the data detection module, whether a data amount of the deduplicated data is greater than a preset data amount threshold to decide whether to initiate the deduplicated data in batches.

20. The method according to claim 11, wherein at least part of the time window of the detection operation is overlapped with a time window of the previous detection operation.
